(19) United States
(12) Patent Application Publication
(10) Pub. No.: US 2026/0360773 A1
(43) Pub. Date: Nov. 12, 2026

(54) SUPPORTING AND CONNECTING BODY FOR SOLID OXIDE FUEL CELL OR ELECTROLYSIS CELL, AND PREPARATION METHOD THEREFOR

(71) Applicant: INSTITUTE OF NEW MATERIALS GUANGDONG ACADEMY OF SCIENCES, Guangzhou, Guangdong (CN)

(72) Inventors: Chen Song, Guangzhou, Guangdong (CN); Min Liu, Guangzhou, Guangdong (CN); Dongdong Dong, Guangzhou, Guangdong (CN); Taikai Liu, Guangzhou, Guangdong (CN); Kui Wen, Guangzhou, Guangdong (CN)

(21) Appl. No.: 19/137,659

(22) PCT Filed: Nov. 17, 2023
(86) PCT No.: PCT/CN2023/132246

§ 371 Date: Jan. 9, 2026

(30) Foreign Application Priority Data
Dec. 16, 2022 (CN) 202211623073.7

(51) Int. Cl. H01M 8/0247; B33Y 40/20; B33Y 80/00; C25B 1/04; C25B 9/65; H01M 8/0232; H01M 8/0236; H01M 8/0258; H01M 8/12; H01M 8/1226

(52) U.S. Cl. CPC H01M 8/0247; B33Y 40/20; B33Y 80/00; C25B 1/04; C25B 9/65; H01M 8/0232; H01M 8/0236; H01M 8/0258; H01M 8/1226; H01M 2008/1293

(57) ABSTRACT

An integrated support and interconnect for solid oxide fuel cells or electrolysis cells, and a preparation method therefor. The method comprises: first, obtaining an integrally formed integrated support and interconnect by means of an additive manufacturing technology, and then preparing through-holes in the surface thereof by means of laser drilling, electron beam drilling or chemical etching technology, such that the integrated support and interconnect has multiple functions of supporting, mass transfer, and serially connecting solid oxide fuel cells or electrolysis cells.

### CROSS-REFERENCE TO RELATED APPLICATIONS

The present application claims the priority to the Chinese patent application with filing No. 202211623073.7 entitled “SUPPORTING AND CONNECTING BODY FOR SOLID OXIDE FUEL CELL OR ELECTROLYSIS CELL, AND PREPARATION METHOD THEREFOR” filed with the Chinese Patent Office on Dec. 16, 2022, which is incorporated by reference herein in its entirety.

### TECHNICAL FIELD

The present disclosure relates to the technical field of cells, and specifically to an integrated support and interconnect (support and connecting body) for solid oxide fuel cell stacks or electrolysis cells.

### BACKGROUND ART

Solid oxide fuel cell (SOFC for short) is an all-solid-state chemical power generation device which directly converts chemical energy stored in fuels and oxidants into electrical energy at medium and high temperatures in an efficient and environment friendly manner, is one of several fuel cells that has the highest theoretical energy density, and possesses a broad application prospect in fields such as distributed power stations, household co-generation systems, and portable power sources. As an inverse process of the SOFC, a solid oxide electrolysis cell (SOEC for short) is an energy storage device that converts electrical energy and thermal energy into chemical energy, and can realize efficient, clean, large-scale hydrogen production through electrolysis of water. In addition to hydrogen production, the SOEC can also be used for electrolysis of CO2, and can directly convert greenhouse gases into fuels. Therefore, in the current social background with increasingly prominent energy and environment problems, SOEC technology also has a broad application prospect.

SOFCs can be classified into ceramic-supported type (including electrolyte-supported type, cathode-supported type, and anode-supported type) and metal-supported type according to different types of support bodies. Compared with ceramic-supported SOFCs, metal-supported SOFCs (MS-SOFCs) have remarkable advantages such as fast start-up speed, high mechanical strength, low cost, and easy stack sealing, and can shorten cell start-up duration from tens of hours to several minutes, so as to be expected to achieve large-scale applications in mobile fields such as vehicles, marine vessels, and unmanned aerial vehicles, with huge market development potentials. However, a conventional technological route for MS-SOFC preparation is “preparation of a porous metal support→preparation of an anode, an electrolyte, and a cathode coating on a surface thereof to form a metal-supported cell sheet→welding the metal-supported cell sheet with a metal connection body→stacking in series and sealing to form a cell stack”. Herein, the porous metal support is typically prepared by a powder metallurgy method such as press forming, tape casting or pressure sintering, and pores of an obtained support are structurally disordered, thus increasing concentration polarization of cells and limiting improvement on cell performance. In addition, the metal support and the metal connection body are respectively prepared as two independent components, and the two need to be welded through technologies such as brazing or laser to form the stack, with a relatively complex preparation process. Meanwhile, a welding position is prone to stress and uneven composition during high-temperature operations of the SOFCs (600-800 °C), and sealing, oxidation resistance, etc. of a weld seam may affect long-term stability of the cells, leading to degraded cell performance.

As described in the above, the metal-supported SOECs also have similar problems.

In view of this, the present disclosure is specifically proposed.

### SUMMARY

The present disclosure aims at providing an integrated support and interconnect for solid oxide fuel cell stacks or electrolysis cells, so as to solve the above technical problems.

The present disclosure is implemented as follows.

In the first aspect, the present disclosure provides an integrated support and interconnect for a solid oxide fuel cell or electrolysis cell, configured to support a single solid oxide fuel cell or electrolysis cell unit, and connect a plurality of solid oxide fuel cell or electrolysis cell units in series to form a stack, where the integrated support and interconnect is integrally formed by an additive manufacturing technology, without additional welding; and then one or a combination of technologies of laser drilling, electron beam drilling or chemical etching technology is used to prepare ordered through holes on a surface thereof, with a controllable structure and smooth inner walls of the holes.

The integrated support and interconnect has a first surface configured for contact with first electrodes of single cell or electrolysis cell units and a second surface provided opposite to the first surface; the integrated support and interconnect is provided therein with a first gas channel, where the first gas channel is provided between the first surface and the second surface, and the first gas channel passes through the integrated support and interconnect along one side of the first surface from to the other side opposite thereto; the second surface is provided with a plurality of protrusions configured for contact with second electrodes having a polarity opposite to the first electrodes of the single cell or electrolysis cell units, and the plurality of protrusions are spaced apart from each other, so as to form a second gas channel between two adjacent protrusions.

The first surface of the integrated support and interconnect is formed with a plurality of through holes are formed on the first surface of the integrated support and interconnect through one or a combination of technologies of laser drilling, electron beam drilling or chemical etching technology, where each through hole extends from the first surface to communicate with the first gas channel.

In some optional embodiments, the plurality of through holes cover the entire first gas channel, each through hole has a diameter of 5-150 μm, preferably 10-60 μm. Preferably, the integrated support and interconnect is made from Ni-based alloy, Fe-based alloy, or Co-based alloy, or the above material added with a ceramic material, where the ceramic material is selected from a certain amount of yttria-or scandia-stabilized zirconia, gadolinia-stabilized ceria, or yttria.

In some optional embodiments, the first gas channel includes a plurality of sub-gas channels provided in parallel at intervals, with two adjacent sub-gas channels being separated by a partition wall.

In the second aspect, the present disclosure further provides a preparation method for the above integrated support and interconnect, including: forming the plurality of through holes on the first surface of the integrally formed connecting body through technologies such as laser drilling, chemical etching or electron beam drilling.

In some optional embodiments, the preparation method includes: obtaining the connecting body through additive manufacturing.

In some optional embodiments, the plurality of through holes are formed by the laser drilling. Optionally, process parameters of the laser drilling are: laser power of 3-1,500 W, a laser frequency of 0.1 Hz-1 MHz, and a pulse width of 5 ps-50 ms.

In some optional embodiments, the plurality of through holes are formed by the electron beam drilling. Optionally, prior to the electron beam drilling, a grit blasting is performed on the first surface. Optionally, process parameters of the electron beam drilling are: pulse power of 0.5-12 kW, pulse frequency of 0.2 kHz-10 kHz, operation current of 1-100 mA, and pulse duration of 50 μs-30 ms.

In the third aspect, the present disclosure further provides a solid oxide fuel cell or electrolysis cell, including the above integrated support and interconnect and electrochemical functional layers formed on the first surface of the integrated support and interconnect.

Optionally, the electrochemical functional layers include an anode layer, an electrolyte layer and a cathode layer.

In the fourth aspect, the present disclosure further provides a preparation method for the above solid oxide fuel cell or electrolysis cell, including: preparing the functional layer on the first surface of the connecting body of the cell stack by a method such as thermal spraying, tape casting and sintering, etc.

Optionally, the thermal spraying is employed to sequentially spray on the first surface to form the anode layer, the electrolyte layer and the cathode layer in sequence, or the thermal spraying is employed to sequentially spray on the first surface to form the cathode layer, the electrolyte layer and the anode layer in sequence.

In the fifth aspect, the present disclosure further provides a solid oxide fuel cell or electrolysis cell stack, including a plurality of the above solid oxide fuel cells or electrolysis cells, where two adjacent solid oxide fuel cells or electrolysis cells are stacked such that the plurality of protrusions of the integrated support and interconnect of one of the two are in contact with a functional layer of the other.

Compared with the prior art, exemplary solutions of the present disclosure at least have beneficial effects as follows.
(1) The present disclosure can realize integrated preparation of the metal support and the connecting body by means of the additive manufacturing technology, significantly improve the preparation efficiency, and can avoid problems, such as weld seam stress/composition non-uniformity caused by the process of welding the two, and unstable cell performance caused by sealing and oxidation resistance of the weld seam.
(2) Compared with the porous metal support prepared by powder metallurgy, the present disclosure prepares holes on the surface of the integrated support and interconnect using the technologies such as laser drilling, electron beam drilling or chemical etching, and obtained pores are structurally ordered through holes, which can remarkably reduce gas delivery paths and resistance, and improve the gas permeability of the integrated support and interconnect. The through holes can be precisely controlled in dimension, density and uniformity, thereby facilitating subsequent thickness reduction and deposition of a functional coating, improving bonding strength between the functional coating and the integrated support and interconnect, reducing cell resistance, and improving cell performance.
(3) Compared with the porous metal support prepared by the conventional laser or electron beam drilling, a through hole plate on a surface of the integrated support and interconnect prepared by the present disclosure has a raised support structure connected thereto in a lower part, which can effectively reduce bending deformation problems of the through-hole plate on the surface during hole preparation and stack welding, while increasing the density of through holes per unit area, and increasing an amount of power generation per unit area of the SOFC.
(4) Compared with the porous metal support prepared by the additive manufacturing, the through-hole structure on the surface of the integrated support and interconnect prepared by the present disclosure is formed by subtractive manufacturing, and inner walls of the pores are smoother, which can further reduce the hole diameter while ensuring a relatively high gas transmission velocity, thereby facilitating subsequent deposition and bonding of the functional layer. In addition, the integrated support and interconnect has lower surface roughness, so as to maintain flatness of various functional coatings during large-area deposition, thereby further realizing thinning of the functional coatings, reducing the cell resistance, and improving the cell performance.

### BRIEF DESCRIPTION OF DRAWINGS

In order to more clearly illustrate technical solutions of embodiments of the present disclosure, drawings which need to be used in the embodiments will be introduced below briefly. It should be understood that the drawings merely show some embodiments of the present disclosure, and thus should not be considered as limitation to the scope. Those ordinarily skilled in the art still could obtain other relevant drawings according to these drawings, without using any inventive efforts.

FIG. 1 is a structural schematic view of an integrated support and interconnect provided by Example 1 of the present disclosure;

FIG. 2 is a structural schematic view of a non-perforated integrated support and interconnect provided by Example 1;

FIG. 3 is a structural schematic view of a solid oxide fuel cell provided by Example 3;

FIG. 4 is a structural schematic view of a solid oxide fuel cell stack provided by Example 4; and

FIG. 5 is a structural schematic view of a surface of through holes of the integrated support and interconnect provided by Example 1 of the present disclosure.

Reference signs: 10—solid oxide fuel cell; 100—integrated support and interconnect; 101—through hole; 110—non-perforated integrated support and interconnect; 111—first surface; 112—second surface; 113—first gas channel; 114—protrusion; 115—second gas channel; 20—solid oxide fuel cell stack; 200—electrochemical functional layers; 210—anode layer; 220—electrolyte layer; 230—cathode layer; 300—sealing material.

### DETAILED DESCRIPTION OF EMBODIMENTS

In order to make objectives, technical solutions and advantages of embodiments of the present disclosure clearer, the technical solutions in the embodiments of the present disclosure will be described clearly and completely below. Embodiments, for which no concrete conditions are specified, are carried out according to conventional conditions or conditions recommended by manufactures. If manufacturers of reagents or apparatuses used are not specified, all of them are conventional products commercially available

### Example 1

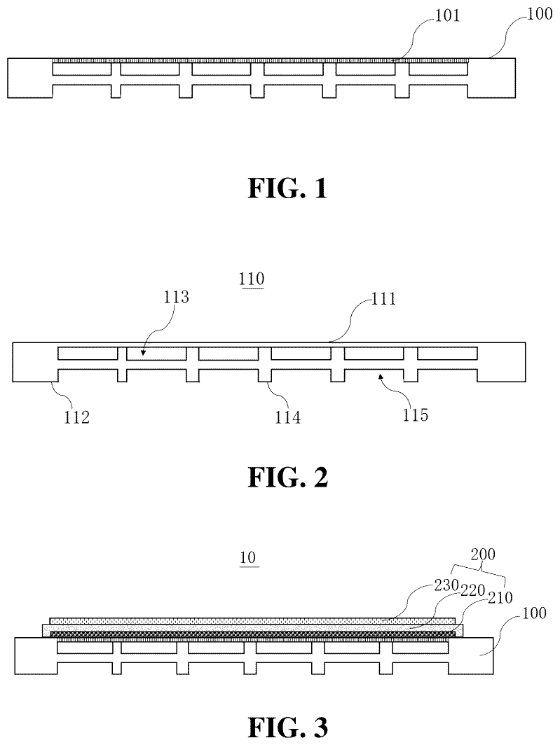

With reference to FIG. 1 to FIG. 4, examples of the present disclosure provide an integrated support and interconnect 100 for connecting a plurality of single cell units in series to form a solid oxide fuel cell stack 20, where the integrated support and interconnect 100 is fabricated from a non-perforated integrated support and interconnect 110 through one or a combination of technologies of laser drilling, electron beam drilling or chemical etching.

Specifically, with reference to FIG. 2, the non-perforated integrated support and interconnect 110 has a first surface 111 for contact with first electrodes of the single cell units and a second surface 112 provided opposite to the first surface 111. The non-perforated integrated support and interconnect 110 is provided therein with a first gas channel 113, where the first gas channel 113 is provided between the first surface 111 and the second surface 112, and the first gas channel 113 passes through the non-perforated integrated support and interconnect 110 along the first surface 111 from one side to the other opposite side. The first gas channel 113 serves as a fuel gas channel for hydrogen, natural gas, or the like of the solid oxide fuel cell to pass therethrough.

For example, in the present example, the first gas channel 113 substantially covers the whole non-perforated integrated support and interconnect 110. Taking that the non-perforated integrated support and interconnect 110 is defined as having a length direction, a width direction and a thickness direction as an example, the first gas channel 113 extends from one end to the other end in the length direction of the non-perforated integrated support and interconnect 110, and has end walls for closing it in the width direction, and a thickness of the first gas channel 113 in the thickness direction is approximately half that of the non-perforated integrated support and interconnect 110. In the present example, the first gas channel 113 includes a plurality of sub-gas channels provided in parallel at intervals, with two adjacent sub-gas channels being separated by a partition wall, which, on one hand, is conducive to orderly flow of the fuel gas, and on the other hand, facilitates better support to the first surface 111. Certainly, in other examples, it is also feasible that the first gas channel 113 is provided as an integral channel as required. In other examples, the first gas channel 113 may also be formed by enclosing four end walls in the length direction and the width direction.

The second surface 112 is provided with a plurality of protrusions 114 for contact with second electrodes having a polarity opposite to the first electrodes of the single cell units, and the plurality of protrusions 114 are spaced apart from each other, so as to form a second gas channel 115 between two adjacent protrusions 114. The second gas channel 115 is a channel for oxygen or air flow. The plurality of protrusions 114 are configured to protrude from the second surface. In the present example, the plurality of protrusions 114 function as series connection and current collection. By providing the plurality of protrusions 114 as contact bodies, it is beneficial to reduce contact surfaces of the integrated support and interconnect 100 in contact with other single cell units, thereby reducing contact resistance.

With further reference to FIG. 2, the plurality of protrusions 114 are not distributed throughout the entire second surface 112 at two ends of the width direction, while some regions are reserved at two sides. The second gas channels 115 formed between the plurality of protrusions 114 serve as flow channels for an oxidant (oxygen or air channel). In the cell stack, the oxidant is in contact with the electrodes of the cell units through the second gas channels 115, and subsequently reacts with the fuel.

It should be noted that, the number of the plurality of protrusions 114 may be selectively configured as required, and is not particularly limited. Likewise, shape and dimension of a single protrusion and an interval between two adjacent protrusions may be separately configured as required, so as to realize adjustment for transmission characteristics such as flow rate of the oxidant. Exemplarily, in the present example, the protrusions 114 are in a cuboid shape, and two adjacent protrusions 114 have an equal interval therebetween.

In the present example, the first surface 111 and structures such as the protrusions 114 on the second surface 112 are integrally formed to obtain the non-perforated integrated support and interconnect 110. For example, in the present example, the non-perforated integrated support and interconnect 110 is manufactured by additive manufacturing. The non-perforated integrated support and interconnect 110 is manufactured by integral forming, thus avoiding problems of complex machining flow caused by welding and unstable device performance. Moreover, the additive manufacturing can realize integrated fabrication of a product without a contact surface, thereby reducing generation of contact resistance caused by introduction of the contact surface.

With reference to FIG. 1, the integrated support and interconnect 100 is obtained by forming a plurality of through holes 101 on the first surface 111 of the integrally formed non-perforated integrated support and interconnect 110 through one or a combination of technologies of laser drilling, electron beam drilling or chemical etching. Each through hole 101 extends from the first surface 111 to communicate with the first gas channel 113, and the plurality of through holes 101 are uniformly distributed at intervals. Specifically, the plurality of through holes 101 cover the whole first gas channel 113, and the diameter of each through hole 101 is 5-150 μm, preferably 10-60 μm. Exemplarily, the through holes are first prepared by laser drilling or electron beam drilling, and then subjected to etching using the chemical etching technology so as to form a finally shaped hole diameter, and burrs generated during drilling is eliminated.

By directly preparing the plurality of through holes 101 through additive manufacturing, due to the diameter requirement of the through holes 101 and the interval requirement between two adjacent through holes 101, residual powder may exist inside a porous structure formed by the plurality of through holes 101 fabricated thereby (not through holes), thus causing increased gas resistance to fuel gas passage, and further reducing air permeability of the integrated support and interconnect 100. Moreover, it is difficult to directly control dimensional accuracy of hole pattern of the porous structure prepared by additive manufacturing, readily causing dimensional non-uniformity of the holes. In addition, the porous structure is directly prepared by additive manufacturing, and the first surface 111 is relatively rough, being adverse to subsequent deposition of electrochemical functional layers of the SOFC.

Therefore, through extensive research and practice, the inventors inventively propose to form a plurality of through holes 101 on the first surface 111 using the laser drilling, electron beam drilling, chemical etching technology, or the like after obtaining the integrally formed non-perforated integrated support and interconnect 110 by additive manufacturing. Particularly, a more gas-permeable straight-hole structure can be obtained by the laser drilling, thereby reducing the gas resistance to the fuel gas passage. Meanwhile, the dimension of the porous structure can be precisely controlled. Moreover, the surface of the laser-perforated porous structure has low roughness, which is beneficial to subsequent deposition of the electrochemical functional layers of the SOFC, and can improve bonding strength of the functional layer with a porous metal connector, reduce the cell resistance, and improve the cell performance.

It should be noted that, since the through holes 101 provided on the surface of the first surface 111 have a small hole diameter, the intervals also need to be preferably smaller than 200 μm. While generally, in order to meet requirements on functional and dimensional performances of the connecting body, a thickness from the first surface 111 to the first gas channel is generally 50-1,000 μm. If a plurality of uniformly distributed through holes 101 with intervals less than 200 μm are directly obtained by laser or electron beam drilling, local thermal stress will cause deformation of the first surface 111 (as shown in FIG. 5). However, in the examples of the present disclosure, since the first gas channel 113 includes a plurality of sub-gas channels provided in parallel, adjacent sub-gas channels are further separated by providing the partition walls therebetween, and the plurality of partition walls are capable of supporting a surface thin plate having the first surface 111, the deformation problem caused by thermal stress during thin plate drilling can be effectively avoided. Therefore, preferably, a channel width of the sub-gas channels is 0.5-10 mm, and a wall thickness of the partition walls is 0.1-5 mm, so as to achieve an optimal supporting effect.

Further, in the present example, the integrated support and interconnect 100 is made from an electrically conductive material, for example, its material is a metal material or a ceramic material with electrical conductivity. Specifically, materials of the integrated support and interconnect 100 include, but are not limited to, Ni-based alloy, Fe-based alloy, Co-based alloy, or the above materials added with a ceramic material, where the ceramic material is exemplarily selected from yttria-or scandia-stabilized zirconia, gadolinia-stabilized ceria, or yttria.

Exemplarily, the material of the integrated support and interconnect 100 may be any one selected from 430 stainless steel, Crofer 22, Fe5Cr 95, Fe-30Cr, Hastelloy-X, LaCrO₃, and Inconel 625.

### Example 2

The present example provided a preparation method for an integrated support and interconnect 100, including: forming a plurality of through holes 101 on a first surface 111 of an integrally formed non-perforated integrated support and interconnect 110 using laser drilling, electron beam drilling or chemical etching technology.

Specifically, the method included steps as follows:
S1, preparing the non-perforated integrated support and interconnect 110 by an additive manufacturing method, where a structure of the prepared non-perforated integrated support and interconnect 110 is as described in Example 1, which is not repeated herein; and
S2, forming the plurality of through holes by laser drilling.

Process parameters of the laser drilling were: laser power of 500 W, a laser frequency of 100 Hz, a pulse width of 1 ms, and a drilling linear speed of 300 mm/s.

Or in other examples, step S2 was forming the plurality of through holes by electron beam drilling. Process parameters of the electron beam drilling might be any value selected from following parameter ranges: pulse power of 0.5-12 kW, a pulse frequency of 0.2kHz-10 kHz, an operation current of 1-100 mA, and a pulse duration of 50 μs-30 ms.

### Example 3

Referring to FIG. 3, the present example provided a solid oxide fuel cell 10, including an integrated support and interconnect 100 and electrochemical functional layers 200 formed on a first surface 111 of the integrated support and interconnect 100.

Specifically, with reference to FIG. 3, the electrochemical functional layers include an anode layer 210, an electrolyte layer 220 and a cathode layer 230. As shown in the drawing, non-porous regions are reserved at two sides of the first surface 111 on the integrated support and interconnect 100, so as to realize sealing for a porous region of the first surface 111 uniformly distributed with a plurality of through holes 101. The anode layer 210 fully covers the porous region, and extends towards two ends to the non-porous regions. The electrolyte layer 220 further covers a surface of the anode layer 210, and extends from a side surface of the anode layer 210 to the first surface 111, so as to further realize sealing for the anode layer 210. The cathode layer 230 further covers a surface of the electrolyte layer 220. The cathode layer 230 and the anode layer 210 are equal in area, with edges of the two being aligned, so as to ensure an effective area of the cell. If the anode layer 210 and the cathode layer 230 have unequal sizes or are not aligned, since the electrolyte can only conduct current longitudinally, the effective area of the cell can be calculated only according to the electrode with a smaller area or an overlapped part.

In general cases, an area of the porous region on the integrated support and interconnect 100 having the plurality of through holes 101 accounts for 80% or more of a total area of the first surface 111, so as to achieve an optimal utilization rate.

It should be noted that in other examples, the anode layer 210 and the cathode layer 230 may also be exchanged in position.

The present example further provided a preparation method for the solid oxide fuel cell 10, including: spraying the electrochemical functional layers 200 on the first surface 111 on the integrated support and interconnect 100.

Specifically, thermal spraying was employed to spray on the first surface 111 to form the anode layer 210, the electrolyte layer 220 and the cathode layer 230 in sequence. The thermal spraying is heating a coating material to melt into extremely fine particles using a high-velocity gas flow, and spraying the fine particles onto a workpiece surface at a very high velocity, thus forming a coating. The thermal spraying method can enable inter-layer bonding performance to be relatively stable, and the coating is not easy to fall off. Moreover, in the present example, after a non-perforated integrated support and interconnect 110 was obtained by additive manufacturing, a grit blasting can be performed on the first surface 111, so as to obtain certain roughness, thus further enabling good bonding of the sprayed anode with a matrix, and avoiding easy peeling off. That is, after the non-perforated integrated support and interconnect 110 was prepared by additive manufacturing, the first surface 111 thereof was first subjected to the grit blasting so as to possess certain roughness, then holes were prepared through a technology such as laser drilling, electron beam drilling or chemical etching, and finally, the thermal spraying was performed to prepare the electrochemical functional layers 200.

It should be noted that in some other examples, the integrated support and interconnect 100 also may be used for preparing a solid oxide fuel electrolysis cell.

### Example 4

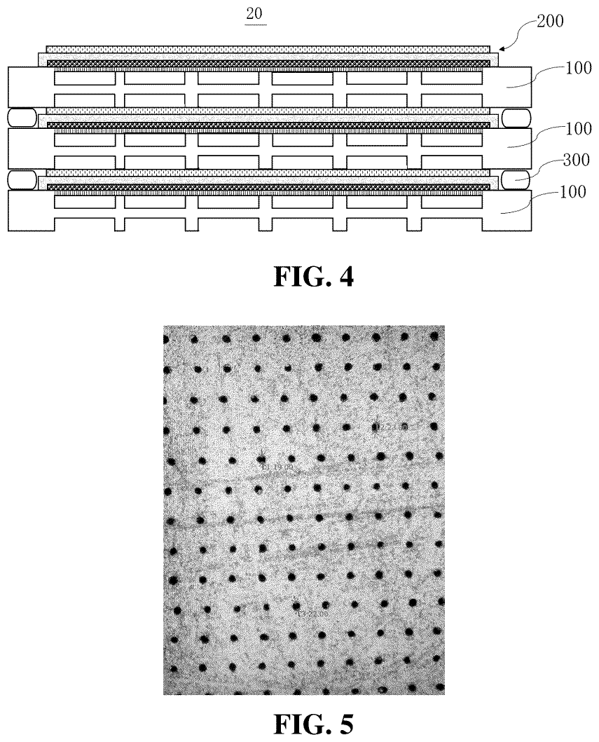

With reference to FIG. 4, the present example provides a solid oxide fuel cell stack 20, including a plurality of solid oxide fuel cells 10, where two adjacent solid oxide fuel cells 10 are stacked such that a plurality of protrusions 114 of an integrated support and interconnect 100 of one solid oxide fuel cell 10 are in contact with electrochemical functional layers 200 of the other solid oxide fuel cell 10. Specifically in the present example, the cell stack may be obtained by connecting four solid oxide fuel cells 20 in series, and from top to bottom, a second surface 112 of the solid oxide fuel cell 20 above having a plurality of protrusions 114 is in contact with a cathode layer 230 of the solid oxide fuel cell 20 below.

A plurality of fuel cell units can be connected together in series through the supporting and connecting bodies 100. It can be seen from FIG. 4 that certain end surfaces reserved at two sides of each integrated support and interconnect 100 for the cells are used for providing a sealing material 300, so as to realize sealing for the cell stack, further preventing oxygen or air from leaking.

In conclusion, on the basis of additive manufacturing, employing the laser drilling, electron beam drilling or chemical etching technology can render a more gas-permeable through-hole structure, so as to reduce the gas resistance to the fuel gas passage, and increase gas permeability of a metal supporting connector. Compared with conventional processes, employing the additive manufacturing technology to prepare the metal supporting connector can eliminate the welding process. In addition, the dimension of the porous structure prepared by the laser drilling and electron beam drilling can be precisely controlled. The surface of the porous structure obtained by laser drilling and electron beam drilling has low roughness, which is beneficial to subsequent deposition of the electrochemical functional layers of the SOFC, and can improve the bonding strength of the functional layer with the porous metal connector, reduce the cell resistance, and improve the cell performance.

The above-mentioned are only for preferred examples of the present disclosure and are not intended to limit the present disclosure. For those skilled in the art, the present disclosure could have various modifications and changes. Any modifications, equivalent substitutions, improvements and the like made within the spirit and principle of the present disclosure should be covered within the scope of protection of the present disclosure.

### INDUSTRIAL APPLICABILITY

The present disclosure realizes the integration of the conventional integrated support and interconnect, significantly improves the preparation efficiency, and avoids the problem of unstable cell performance caused by the welding process. The through-hole plate on the surface of the obtained integrated support and interconnect is not prone to deformation, and the through-hole structure thereof can be finely controlled, thereby improving the air permeability of the integrated support and interconnect, the bonding strength with the functional layer and the amount of power generation per unit area, and facilitating in obtaining high-performance solid oxide fuel cells or electrolysis cell stacks. Therefore, the present disclosure is conducive to industrialization of the solid oxide fuel cells, and has optimal application prospects.

1. An integrated support and interconnect for a solid oxide fuel cell or electrolysis cell, configured to support a single solid oxide fuel cell or electrolysis cell unit, and connect a plurality of solid oxide fuel cell or electrolysis cell units in series to form a stack, wherein the integrated support and interconnect is integrally formed by an additive manufacturing technology, without additional welding; and then one or a combination of technologies of laser drilling, electron beam drilling or chemical etching technology is used to prepare ordered through holes on a surface thereof, with a controllable structure and smooth inner walls of the holes;
the integrated support and interconnect has a first surface configured for contact with first electrodes of single cell or electrolysis cell units and a second surface provided opposite to the first surface; the integrated support and interconnect is provided therein with a first gas channel, wherein the first gas channel is provided between the first surface and the second surface, and the first gas channel passes through the integrated support and interconnect along one side of the first surface to the other side opposite thereto; the second surface is provided with a plurality of protrusions configured for contact with second electrodes having a polarity opposite to the first electrodes of the single cell or electrolysis cell units, and the plurality of protrusions are spaced apart from each other, so as to form a second gas channel between two adjacent protrusions; and
the first surface of the integrated support and interconnect is formed with a plurality of through holes through one or a combination of technologies of laser drilling, electron beam drilling or chemical etching technology, wherein each of the through holes extends from the first surface to communicate with the first gas channel.

2. The integrated support and interconnect according to claim 1, wherein the plurality of through holes are uniformly distributed at intervals on the first surface.

3. The integrated support and interconnect according to claim 2, wherein the plurality of through holes cover the entire first gas channel, each through hole has a diameter of 5-150 μm, and a distance between adjacent through holes is 5-500 μm.

4. The integrated support and interconnect according to claim 3, wherein the diameter of each through hole is 10-60 μm, and the distance between two adjacent through holes is less than 200 μm.

5. The integrated support and interconnect according to claim 1, wherein the integrated support and interconnect is made from Ni-based alloy, Fe-based alloy, Co-based alloy, or the above materials added with a ceramic material.

6. The integrated support and interconnect according to claim 5, wherein the ceramic material is selected from yttria-or scandia-stabilized zirconia, gadolinia-stabilized ceria, or yttria.

7. The integrated support and interconnect according to claim 1, wherein the first gas channel comprises a plurality of sub-gas channels provided in parallel at intervals, with two adjacent sub-gas channels being separated by a partition wall.

8. The integrated support and interconnect according to claim 7, wherein a channel width of the sub-gas channels is 0.5-10 mm, and a wall thickness of the partition wall is 0.1-5 mm.

9. A preparation method for the integrated support and interconnect according to claim 1, comprising: obtaining the integrated support and interconnect by additive manufacturing, and forming the plurality of through holes on the first surface of the integrated support and interconnect through one or a combination of technologies of laser drilling, electron beam drilling or chemical etching technology.

10. The preparation method for the integrated support and interconnect according to claim 9, wherein the through holes are first prepared by the laser drilling or the electron beam drilling, and then subjected to etching by the chemical etching technology so as to form a final shaped hole diameter, and burrs generated during drilling is eliminated.

11. The preparation method for the integrated support and interconnect according to claim 9, wherein the plurality of through holes are formed by the laser drilling.

12. The preparation method for the integrated support and interconnect according to claim 11, wherein prior to the laser drilling, a grit blasting is performed on the first surface.

13. The preparation method for the integrated support and interconnect according to claim 11, wherein process parameters of the laser drilling are:
laser power of 3-1,500 W, a laser frequency of 0.1 Hz-1 MHz, and a pulse width of 5 ps-50 ms.

14. The preparation method for the integrated support and interconnect according to claim 9, wherein the plurality of through holes are formed by the electron beam drilling.

15. The preparation method for the integrated support and interconnect according to claim 14, wherein prior to the electron beam drilling, a grit blasting is performed on the first surface.

16. The preparation method for the integrated support and interconnect according to claim 14, wherein process parameters of the electron beam drilling are: pulse power of 0.5-12 kW, pulse frequency of 0.2 kHz-10 kHz, operation current of 1-100 mA, and pulse duration of 50 μs-30 ms.

17. A solid oxide fuel cell or electrolysis cell, comprising the integrated support and interconnect according to claim 1 and a functional layer formed on the first surface of the integrated support and interconnect.

18. The solid oxide fuel cell or electrolysis cell according to claim 17, wherein the functional layer comprises an anode layer, an electrolyte layer and a cathode layer.

19-21. (canceled)
